(19) United States
(12) Patent Application Publication
(10) Pub. No.: US 2021/0125282 A1
(43) Pub. Date: Apr. 29, 2021

(54) Information Processing Method, Information Processing Apparatus and Non-Transitory Computer-Readable Storage Medium

(71) Applicant: United Smiles Co., Ltd., Tokyo (JP)

(72) Inventor: Kiyohiro Saburi, Tokyo (JP)

(21) Appl. No.: 17/143,639

(22) Filed: Jan. 7, 2021

Related U.S. Application Data
(63) Continuation of application No. PCT/JP2019/026921, filed on Jul. 8, 2019.

(30) Foreign Application Priority Data
Jul. 19, 2018 (JP) 2018-136130

(51) Int. Cl. G06Q 40/04; G06Q 20/36; G06Q 20/40; G06Q 20/38; G06Q 10/10; G06Q 50/00; G06Q 30/02; H04L 9/30; H04L 9/32

(52) U.S. Cl. CPC G06Q 40/04; G06Q 20/3678; G06Q 20/405; G06Q 20/389; G06Q 10/10; G06Q 50/01; G06Q 20/0655; G06Q 30/0216; G06Q 10/1053; H04L 9/30; H04L 9/3236; G06Q 2230/00; G06Q 30/0214

(57) ABSTRACT

An information processing method, comprising: receiving an investment amount for a movie work from a wallet of an investor; storing the investment amount for each investor on blockchain; acquiring information on box-office revenue of the movie work after a target figure to produce the movie work is achieved; and distributing the box-office revenue to each investor according to the investment amount and a profit distribution rule. This makes it possible to achieve proper fund raising and profit distribution for a movie work or the like.

### CROSS-REFERENCE TO RELATED APPLICATIONS

This application is a continuation application of PCT International Application No. PCT/JP2019/026921, which has International filing date of Jul. 8, 2019 and designated the United States of America, and claiming priority on Patent application No. 2018-136130 filed in Japan on Jul. 19, 2018.

### FIELD

The present invention relates to an information processing method, an information processing device and an information processing program.

### BACKGROUND

Conventionally, a method is provided of presenting a project planning of a copyrighted work of a movie to a purchaser when a producer produces the work and of gaining a production expense and a target profit by making the purchaser purchase the project planning (see Japanese Patent Application Laid-Open No. 2007-172017, for example).

### SUMMARY

The conventional technique, however, has a problem of proper profit distribution.

The present disclosure is made in view of such circumstances and an object is to provide an information processing method, etc. capable of achieving proper fund raising and profit distribution on a movie work, etc.

An information processing method according to an aspect of the present disclosure comprises: receiving an investment amount for a movie work from a wallet of an investor; storing the investment amount for each investor on blockchain; acquiring information on box-office revenue of the movie work after a target figure to produce the movie work is achieved; and distributing the box-office revenue to each investor according to the investment amount and a profit distribution rule.

According to an aspect of the present disclosure, it is possible to achieve proper fund raising and profit distribution for a movie work or the like.

The above and further objects and features will more fully be apparent from the following detailed description with accompanying drawings.

### BRIEF DESCRIPTION OF THE DRAWINGS

FIG. 1 is an illustrative view illustrating the outline of a fund raising and profit distribution system for a movie work.

FIG. 2 illustrates the operation of exchange processing between legal currency and virtual currency.

FIG. 3 is a block diagram illustrating the configuration example of a server.

FIG. 4 illustrates one example of the record layout of a project information DB.

FIG. 5 illustrates one example of the record layout of a planner DB.

FIG. 6 illustrates one example of the record layout of an investor DB.

FIG. 7 illustrates one example of the record layout of a digital signature DB.

FIG. 8 is a block diagram illustrating the configuration example of a terminal.

FIG. 9 is a block diagram illustrating the configuration example of a box-office revenue server.

FIG. 10 illustrates one example of the record layout of a box-office revenue DB.

FIG. 11A illustrates operation of fund-raising processing for a movie work.

FIG. 11B illustrates operation of the fund-raising processing for a movie work.

FIG. 11C illustrates operation of the fund-raising processing for a movie work.

FIG. 12A illustrates operation of profit distribution processing.

FIG. 12B illustrates operation of profit distribution processing.

FIG. 13 is a flowchart showing a processing procedure performed when an investment in a movie work is made.

FIG. 14 is a flowchart showing a processing procedure of a subroutine for creating a wallet address.

FIG. 15 is a flowchart showing a processing procedure performed when a distribution amount based on box-office revenue information is transmitted.

FIG. 16 is a flowchart showing a processing procedure performed when a distribution amount is transmitted to an investor or an investment amount is returned to the investor.

FIG. 17 illustrates one example of the record layout of an investor DB according to Embodiment 2.

FIG. 18A illustrates the outline of a fund-raising system using an SNS.

FIG. 18B illustrates the outline of the fund-raising system using an SNS.

FIG. 19 is a flowchart showing a processing procedure performed when fund-raising in cooperation with an SNS is performed.

FIG. 20 illustrates the outline of a vote system for casting votes for a cast and a production company.

FIG. 21 is a block diagram illustrating the configuration example of a server according to Embodiment 3.

FIG. 22 illustrates one example of the record layout of a vote DB.

FIG. 23 is a flowchart of a processing procedure performed when votes for a cast and a production company are made.

FIG. 24 illustrates one example of a record layout of a box-office revenue DB according to Embodiment 4.

FIG. 25 is a flowchart showing a processing procedure performed when box-office revenue is distributed by month.

FIG. 26 illustrates one example of the record layout of an investor DB according to Embodiment 5.

FIG. 27 illustrates one example of the record layout of a box-office revenue DB according to Embodiment 5.

FIG. 28 is a conceptual drawing illustrating profit distribution depending on the degree of achievement of a target figure.

FIG. 29 is a block diagram illustrating the configuration example of a server according to Embodiment 6.

FIG. 30 illustrates one example of the record layout of a register DB.

FIG. 31 illustrates one example of the record layout of a vote DB according to Embodiment 6.

FIG. 32A illustrates operation of casting a vote and browsing vote information in a vote system.

FIG. 32B illustrates operation of casting a vote and browsing vote information in the vote system.

### DETAILED DESCRIPTION

The present disclosure will be described below with reference to the drawings depicting embodiments.

### Embodiment 1

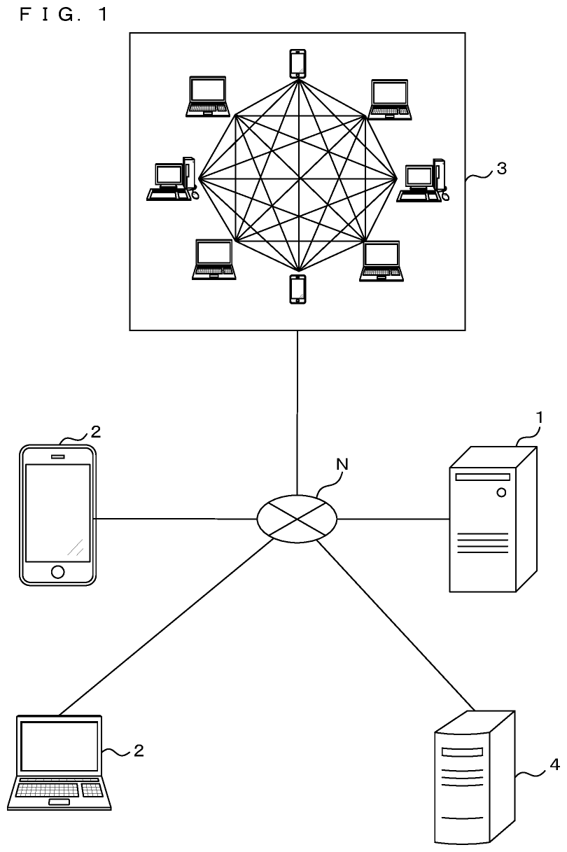

FIG. 1 is an illustrative view illustrating the outline of a fund raising and profit distribution system for a movie work.

The system according to the present embodiment includes an information processing device 1, an information processing terminal 2, blockchain 3 and a box-office revenue processing device 4. Information is transmitted and received through a network N such as the Internet or the like between them. Though a movie work is described as an example in the present embodiment, the present disclosure can also be applied to a game work.

The information processing device 1 is an information processing device for processing, storing and transmitting and receiving various information such as project information and investment information on a movie work and is, for example, a server device, a personal computer or the like. In the present embodiment, the information processing device 1 is assumed as a server device and is referred to as a server 1 for the sake of simplicity.

The information processing terminal 2 is a terminal device for transmitting an investment amount for a movie work, acquiring box-office revenue for a movie work and casting a vote for a movie work. The information processing terminal 2 is an information processing device, for example, a smartphone, a cellular phone, a tablet, a personal computer terminal or the like. For the sake of simplicity, the information processing terminal 2 is referred to as a terminal 2.

The blockchain 3 is composed of multiple nodes and corresponds to a distributed ledger technology or a distributed network. The blockchain 3 generates a unit of data called a block at every prescribed interval of time and stores the data in a connected manner like a chain. The blockchain 3 is autonomously managed by using a peer to peer network and a distributed timestamp server. Once that data in the blocks is held like a chain and stored, the data cannot be changed retrospectively. It is noted that any type of the blockchain 3 may be employed including public blockchain and private blockchain.

The box-office revenue processing device 4 is an information processing device for storing information on gross revenue relating to box-office revenue, the ratio of a production cost, the ratio of an investor, etc. and transmitting and receiving such information and is, for example, a server device, a personal computer or the like. Note that the box-office revenue processing device 4 is a box-office revenue DB such as ChainaBox Office (registered trademark) or the professional version of Maoyan (registered trademark), for example. In the present embodiment, the box-office revenue processing device 4 is assumed as a server device and is thus referred to as a box-office revenue server 4 for the sake of simplicity. It is noted that the server 1 and the box-office revenue server 4 may be employed as a single unit.

Succeedingly, the entire flow of fund raising and profit distribution is described. The server 1 receives and stores project information on a movie work. The project information may contain a project and development proposal, a scenario, a plot and a planner for producing a movie work, for example. The server 1 receives and stores a profit distribution rule. The profit distribution rule is information on, for example, a distribution rule for box-office revenue, a distribution rule for a bonus to be acquired when an investor makes an introduction of another person and the like. The server 1 transmits a transaction including a smart contract in which the project information and the profit distribution rule are described to the blockchain 3. The smart contract will be described later.

The terminal 2 receives an investment amount for the movie work based on the project information of the movie work from the wallet of the investor. The investor may be a supporter of a cast appearing in the movie work or may be an investor who makes an investment in the movie to gain a profit, for example. The type of currencies to be invested may include legal currency and virtual currency that is mutually exchangeable for the legal currency. The virtual currency may be, for example, Kyvalion (registered trademark) or a bitcoin (registered trademark). In the case where the investor makes an investment in the movie work by using legal currency, the wallet of the investor may be LINE (registered trademark) application wallet or the WeChat Pay (registered trademark) application. An exchange between legal currency and virtual currency will be described below.

In the case where an investor makes an investment in a movie work by using virtual currency, the wallet of the investor is a wallet for transmitting and receiving virtual currency by a wallet address and storing virtual currency. The wallet address is an account number for virtual currency created for each transaction and is displayed as a character string or a QR code (registered trademark). The wallet address is an address mathematically extracted based on a public-key cryptography used in the blockchain 3. Furthermore, the wallet addresses of a transmission source and a transmission destination are stored on the blockchain 3 and are not tampered as long as the system of the blockchain 3 is maintained. The wallet address is generated by calculation and thus can be created online or offline.

The terminal 2 transmits the received investment amount for the movie work to the blockchain 3. The blockchain 3 stores the investment amount transmitted from the terminal 2. After the target figure to produce the movie work is achieved, the server 1 acquires box-office revenue information on the shown movie work from the box-office revenue server 4. The server 1 calculates a distribution amount (total amount) for all of the investors and transmits the calculated amount to the blockchain 3. The calculation method for the distribution amount is obtained by first subtracting expenses for a production company, advertising expenses, etc. from the box-office revenue and then dividing the subtracted amount to the investors depending on an investment ratio of each of the investors.

It is noted though the configuration example of the system including the box-office revenue server 4 is shown in the present embodiment, the system configuration is not limited thereto. The server 1 may communicate with a communicatable external box-office revenue device, such as a ChinaBoxOffice DB (not illustrated) that announces the box-office revenue of movies in China, Japan, the United States, etc. to acquire necessary box-office revenue information. The target figure includes a first target and a second target. The first target includes a production cost for a pilot video while the second target includes a production cost for a movie work. It is noted that the classification method for the target figure is not limited to ones described above. For example, the first target, the second target and the third target are defined, and the details of each of the targets may be decided.

The blockchain 3 determines a distribution amount for each of the investors according to the code of the smart contract in which the profit distribution rule is described and the investment amount, and transmits the determined distribution amount to the wallet address of each of the investors. Meanwhile, in the case where the target figure is not achieved within a predetermined time period, the blockchain 3 automatically returns the investment amount of each of the investors to the wallet address of each of the investors by the code in the smart contract.

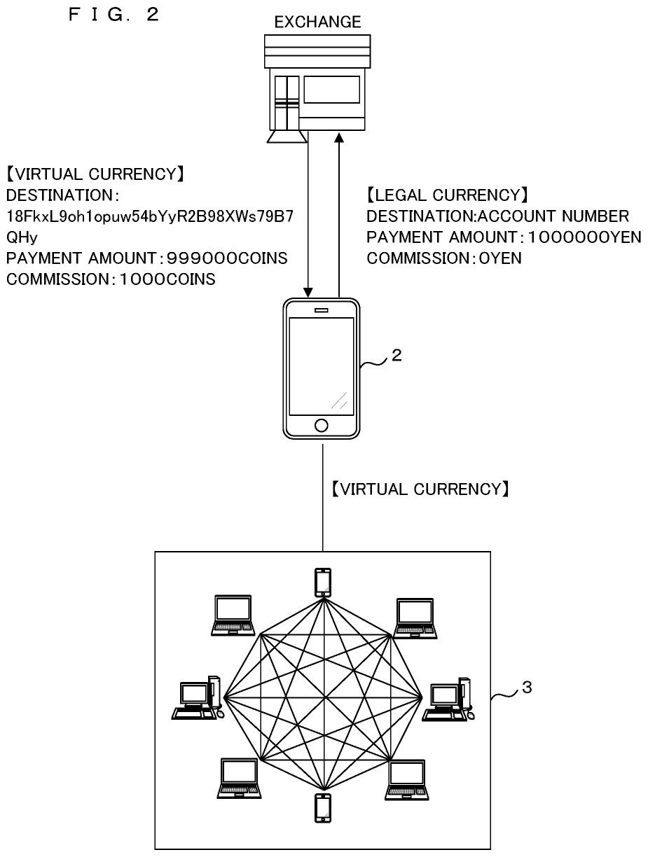

FIG. 2 illustrates the operation of exchange processing between legal currency and virtual currency. The flow of the exchange processing between legal currency and virtual currency will be described while taking WeChat Pay app as an example. If receiving one million yen from the WeChat Pay app, the terminal 2 transmits the received one million yen to the account number of an exchange. An information processing device at the exchange calculates a virtual currency quantity from the received legal currency of one million yen. The virtual currency may be calculated as an equivalent to the legal currency or may be calculated based on a market variable price. It is noted that, in the present embodiment, an example where virtual currency is calculated by performing an equivalent exchange for the legal currency will be described.

The information processing device at the exchange acquires the wallet address of the terminal 2 and transmits one million coins to the acquired wallet address. If a commission is charged, the virtual currency quantity from which the virtual currency quantity corresponding to a predetermined transaction fee is subtracted may be transmitted, for example. The terminal 2 thus can invest in the movie work via the blockchain 3 using the exchanged virtual currency.

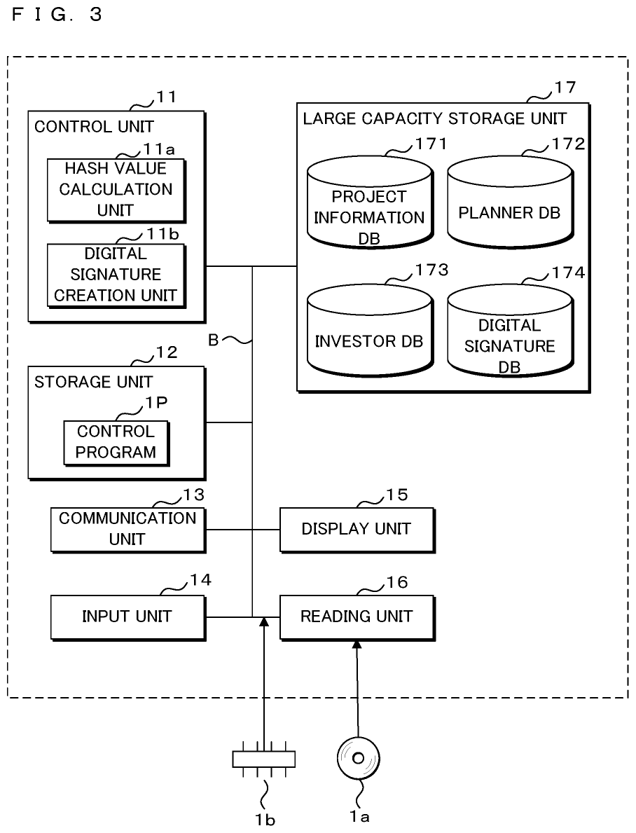

FIG. 3 is a block diagram illustrating the configuration example of the server 1. The server 1 includes a control unit 11, a storage unit 12, a communication unit 13, an input unit 14, a display unit 15, a reading unit 16 and a large capacity storage unit 17. The respective components are connected with each other by buses B.

The control unit 11 includes an arithmetic processing device such as a central processing unit (CPU), a micro-processing unit (MPU) or the like and performs various information processing, control processing and the like related to the server 1 by reading and executing a control program 1P stored in the storage unit 12. Furthermore, the control unit 11 includes a hash value calculation unit 11a and a digital signature creation unit 11b. The hash value calculation unit 11a performs processing of calculating a hash value of various information using a cryptographical hash function. The digital signature creation unit 11b creates a signature for digital authentication based on the public-key cryptography in order to prevent falsification and tampering. It is noted that though the control unit 11 is described as a single processor in FIG. 3, a multiprocessor may be used.

The storage unit 12 includes memory elements such as a random access memory (RAM), a read only memory (ROM), etc. and stores the control program 1P, data, etc. required for the control unit 11 to execute processing. Furthermore, the storage unit 12 temporarily stores data, etc. required for the control unit 11 to execute arithmetic processing. The communication unit 13 includes a processing circuit, etc. for performing communication processing, and transmits and receives information with the terminal 2, the blockchain 3 or the like over the network N.

The input unit 14 is an input device such as a mouse, a keyboard, a touch panel, a button or the like and outputs the received operation information to the control unit 11. The display unit 15 is a liquid crystal display, an organic electroluminescent (EL) display or the like and displays various information according to an instruction of the control unit 11.

The reading unit 16 reads a portable storage unit 1a including a compact disc (CD)-ROM or a digital versatile disc (DVD)-ROM. The control unit 11 may read a control program 1P from the portable storage medium 1a via the reading unit 16 and store the read program in the large capacity storage unit 17. Furthermore, the control unit 11 may download a control program 1P from another computer over the network N or the like and store the downloaded program in the large capacity storage unit 17. Moreover, the control unit 11 may read a control program 1P from a semiconductor memory 1b.

The large capacity storage unit 17 is a storage device with large capacity including a hard disk, or the like. The large capacity storage unit 17 includes a project information DB 171, a planner DB 172, an investor DB 173 and a digital signature DB 174. The project information DB 171 stores project information at a stage of planning a movie work. The planner DB 172 stores information on an organization and an individual proposing a project to produce a movie work. The investor DB 173 stores information on an investor who makes an investment in a movie work. The digital signature DB 174 stores a public key and a secret key for a digital signature based on the public-key cryptography.

It is noted that, in the present embodiment, the storage unit 12 and the large capacity storage unit 17 may be configured as a single storage device. Alternatively, the large capacity storage unit 17 may be formed by multiple storage devices. Alternatively, the large capacity storage unit 17 may be an external storage device connected to the server 1.

In the present embodiment, the server 1 may, not limited to the above-described configuration, include, for example, a microphone for converting sound into an electric signal, a speaker for converting an electric signal to sound, or the like. Though the server 1 is described as a single unit in the present embodiment, the configuration of the server 1 is not limited thereto. For example, the server 1 may be constituted by multiple physical servers, or may be constituted by multiple virtual machines.

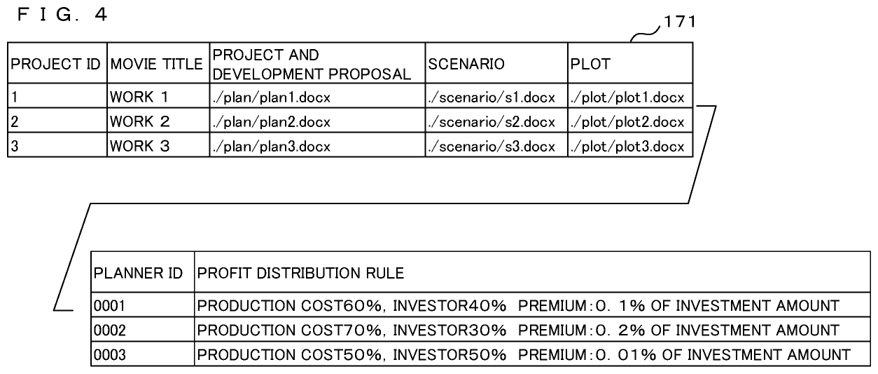

FIG. 4 illustrates one example of the record layout of the project information DB 171. The project information DB 171 includes a project ID column, a movie title column, a project and development proposal column, a scenario column, a plot column, a planner ID column and a profit distribution rule column.

The project ID column stores the ID of a project uniquely specified for identifying each project. The movie title column stores the title of a planned movie. The project and development proposal column stores a file name describing the details of the project of a movie. The scenario column stores a file name describing the scenario of a movie work. The plot column stores a file name describing the plot of a movie work. It is noted that a file name with a path (location for storing a file) is stored in the present embodiment, though not limited thereto. For example, the project and development proposal column may store the details of a project itself. The planner ID column stores the ID of a planner who makes a proposal for a movie work. The profit distribution rule column stores the information on a distribution rule related to box-office revenue, information on a distribution rule related to a bonus acquired when an investor makes an introduction of another person and the like.

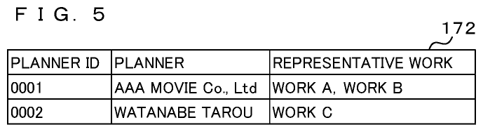

FIG. 5 illustrates one example of the record layout of the planner DB 172. The planner DB 172 includes a planner ID column, a planner column and a representative work column. The planner ID column stores the ID of a planner uniquely specified for identifying each planner. The planner column stores the name of a planner or the name of an organization that makes a proposal.

The representative work column stores information on a past representative work concerning this planner.

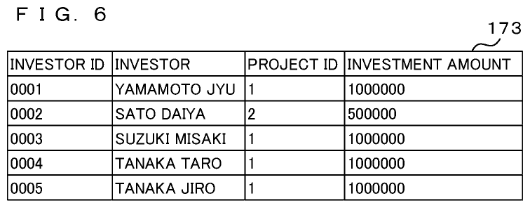

FIG. 6 illustrates one example of the record layout of the investor DB 173. The investor DB 173 includes an investor ID column, an investor column, a project ID column and an investment amount column. The investor ID column stores the ID of an investor uniquely specified for identifying each investor. The investor column stores the name of an investor or the name of an organization that makes an investment. The project ID column stores the project ID of a movie work in which the investor makes an investment. The investment amount column stores an investment amount the investor makes an investment in the movie work associated with the project ID. It is noted that the investment amount may be based on legal currency as well as virtual currency (coin).

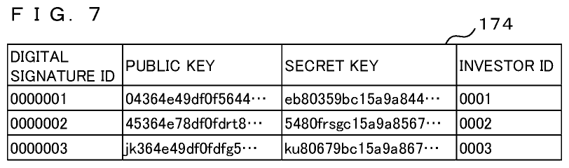

FIG. 7 illustrates one example of the record layout of the digital signature DB 174. The digital signature DB 174 includes a digital signature ID column, a public key column, a secret key column and an investor ID column. The digital signature ID column stores the ID of a digital signature uniquely specified for identifying each digital signature. The public key column stores data on a key that is publicized to a third party in the public-key cryptography. The secret key column stores data on a key that is not publicized to a third party in the public-key cryptography.

Note that the storing manner of each DB as described above is one example and another storing manner may be employed as long as the relation between the data is maintained.

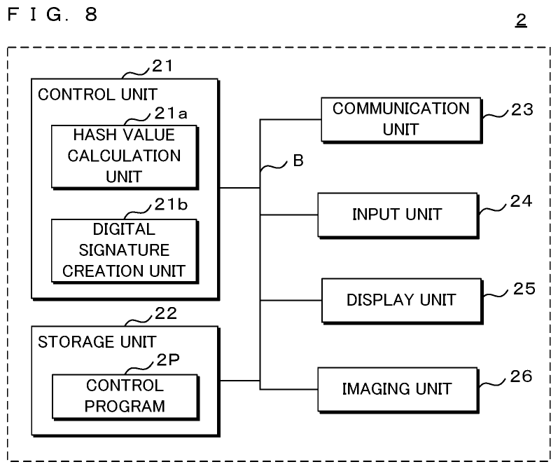

FIG. 8 is a block diagram illustrating the configuration example of the terminal 2. The terminal 2 includes a control unit 21, a storage unit 22, a communication unit 23, an input unit 24, a display unit 25 and an imaging unit 26. The components are connected by buses B.

The control unit 21 includes an arithmetic processing device such as a CPU, an MPU or the like and performs various information processing, control processing and the like related to the terminal 2 by reading and executing a control program 2P stored in the storage unit 22. Furthermore, the control unit 21 includes a hash value calculation unit 21a and a digital signature creation unit 21b. The hash value calculation unit 21a performs processing of calculating a wallet address or the like by using a cryptographical hash function. The digital signature creation unit 21b creates a signature for digital authentication based on the public-key cryptography in order to prevent falsification and tampering. Though the control unit 11 is described as a single processor in FIG. 8, it may be a multiprocessor. The storage unit 22 includes memory elements such as a RAM, a ROM or the like and stores the control program 2P, data, etc. required for the control unit 21 to execute processing. Furthermore, the storage unit 22 temporarily stores data, etc. required for the control unit 21 to execute arithmetic processing.

The communication unit 23 includes a processing circuit for performing communication processing, and transmits and receives information with the server 1 and the blockchain 3 or the like over the network N. The input unit 24 is a keyboard or a mouse. The display unit 25 is a liquid crystal display, an organic EL display or the like and displays various information according to an instruction of the control unit 21. Alternatively, the input unit 24 may be a touch panel integrated with the display unit 25. The imaging unit 26 is an imaging device such as a CCD camera, a CMOS camera or the like. It is noted that the imaging unit 26 may be configured to allow for imaging so as to be directly connected to the terminal 2 outside thereof without being contained in the terminal 2.

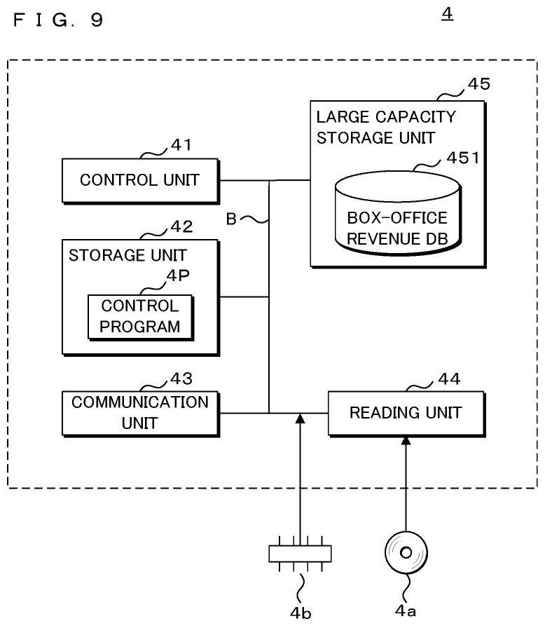

FIG. 9 is a block diagram illustrating the configuration example of the box-office revenue server 4. The box-office revenue server 4 includes a control unit 41, a storage unit 42, a communication unit 43, a reading unit 44 and a large capacity storage unit 45. The respective components are connected by buses B.

The control unit 41 includes an arithmetic processing device such as a CPU, an MPU or the like and performs various information processing, control processing and the like related to the box-office revenue server 4 by reading and executing a control program 4P stored in the storage unit 42. It is noted that though the control unit 41 is described as a single processor in FIG. 9, it may be a multiprocessor.

The storage unit 42 includes memory elements such as a RAM, a ROM and the like and stores the control program 4P required for the control unit 41 to execute processing. Furthermore, the storage unit 42 temporarily stores data, etc. required for the control unit 41 to execute arithmetic processing. The communication unit 43 includes a processing circuit for performing communication processing, and transmits and receives information with the server 1 or the like over the network N.

The reading unit 44 reads out a portable storage unit 4a including a CD-ROM or a DVD-ROM. The control unit 41 may read out a control program 4P from the portable storage medium 4a via the reading unit 44 and store the read program in the large capacity storage unit 45. Furthermore, the control unit 41 may download a control program 4P from another computer over the network N or the like and store the downloaded program in the large capacity storage unit 45. Moreover, the control unit 41 may read a control program 4P from a semiconductor memory 4b.

The large capacity storage unit 45 is a storage device with a large capacity including a hard disk, for example. The large capacity storage unit 45 includes a box-office revenue DB 451. The box-office revenue DB 451 stores information on a gross revenue, a profit distribution ratio, etc. related to a box-office revenue of a movie work.

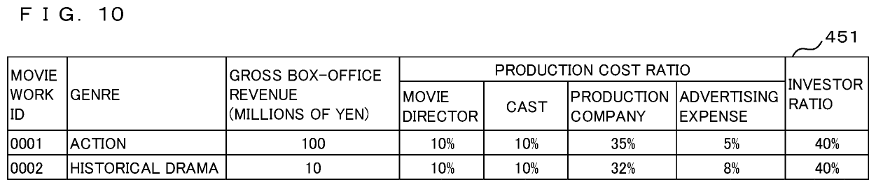

FIG. 10 illustrates one example of the record layout of the box-office revenue DB 451. The box-office revenue DB 451 includes a movie work ID column, a genre column, a gross box-office revenue (millions of yen) column, a production cost ratio column and an investor ratio column. The movie work ID column stores the ID of a movie work uniquely specified for identifying each movie work. The genre column stores category information of a movie work. The category of a movie work includes, for example, a horror, romance, action, historical movie, etc. with reference to a common feature such as a subject matter, a theme and a narrative form, etc. The gross box-office revenue (millions of yen) column stores the gross amount of the box-office revenue.

The production cost ratio column includes a movie director column, a cast column, a production company column and an advertising expense column. The movie director column stores information on the ratio at which the box-office revenue of a movie work is distributed to the movie director. The cast column stores information on the ratio at which the box-office revenue of a movie work is distributed to a cast. The production company column stores information on the ratio at which the box-office revenue of a movie work is distributed to a production company. The advertising expense column stores information on the ratio at which the box-office revenue of a movie work is distributed as advertising expenses. The investor ratio column stores information on the ratio at which the box-office revenue of a movie work is distributed to an investor. It is noted that the information on the ratio at which the box-office revenue is to be distributed is mere one example and is not limited thereto.

It is noted that the storing manner of the box-office revenue DB 451 is mere one example, and another storage manner may be employed as long as the relation between data is maintained.

Succeedingly, one example of the fund-raising and profit-distribution processing using virtual currency will be described.

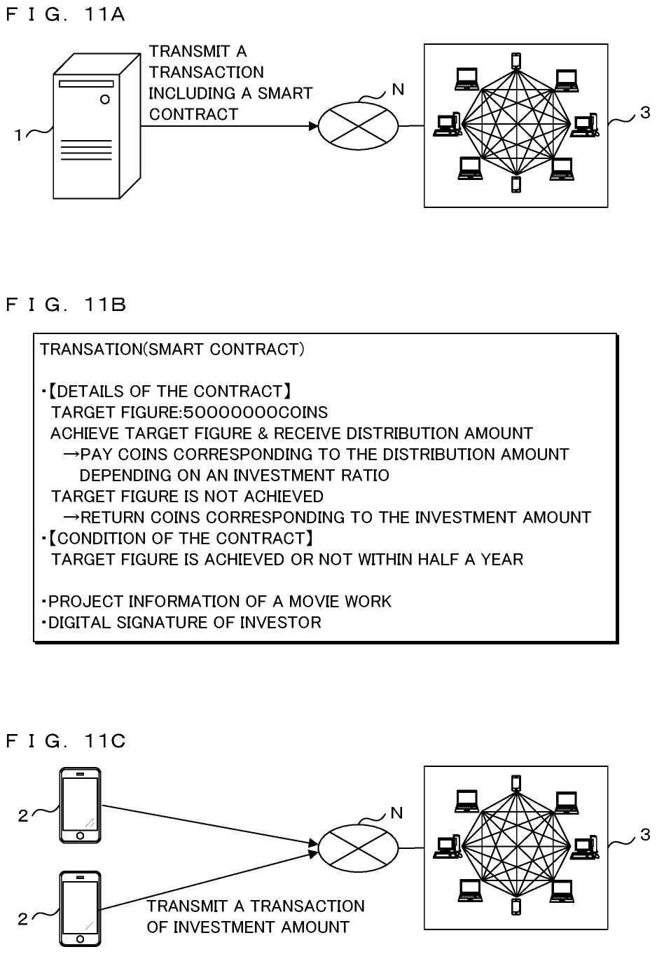

FIGS. 11A, 11B and 11C each illustrate operation of fund-raising processing for a movie work. FIG. 11A illustrates the operation of transmission processing of the project information on a movie work. The control unit 11 of the server 1 receives the project information related to a movie work by the input unit 14 and stores the received project information as one record in each of the project information DB 171 and the planner DB 172 of the large capacity storage unit 17. More specifically, the control unit 11 assigns a unique planner ID for identifying the planner of the movie work to the planner and stores the received planner and representative work of the planner in the planner DB 172 as one record. The control unit 11 assigns a unique project ID for identifying the project information of the movie work to the project and stores the received movie title, project and development proposal, scenario, plot, planner ID and profit distribution rule in the project information DB 171 as one record. In the present embodiment the project information is received by, though not limited to, the input unit 14. For example, project information may be transferred to the server 1 by a portable storage medium such as a universal serial bus (USB) or the like or an external device (not illustrated). The control unit 11 transmits a transaction including a smart contract in which the project information and the profit distribution rule for the movie work are described to the blockchain 3 via the communication unit 13.

FIG. 11B is a conceptual drawing of a transaction including the code for a smart contract. The transaction includes the code for the smart contract, the project information on a movie work and the digital signature of a payer. The smart contract includes the definition of an enforcement condition and details of the contract that have already been programmed and incorporated in the transaction, and automatically implements the contract if a transaction being coincident with the enforcement condition and the details of the contract occurs.

In the present embodiment, if an enforcement condition that a predetermined target figure for a movie work is achieved within half a year is met, the project of the movie work is established. The blockchain 3 confirms the state of receipt of money by the distribution amount for the shown movie work. The condition of making payment to the investors is met at a time when the state of receipt of money by the distribution amount is confirmed, and thus the blockchain 3 transmits the virtual currency quantity (coin) corresponding to the distribution amount to the wallet address of the investor. If an enforcement condition that a target figure for the movie work is not achieved within half a year is met, the blockchain 3 automatically returns the virtual currency quantity corresponding to the investment amount to the wallet address of the investor since the project of the movie work is not established.

FIG. 11C illustrates the operation of processing performed when an investment amount is transmitted to the blockchain 3. The control unit 21 of the terminal 2 transmits a transaction including the virtual currency quantity corresponding to the investment amount to the blockchain 3 by the communication unit 23 based on the project information of the movie work stored in the blockchain 3. The blockchain 3 receives the transaction transmitted from the terminal 2 and stores the wallet address of the investor and the virtual currency quantity corresponding to the investment amount.

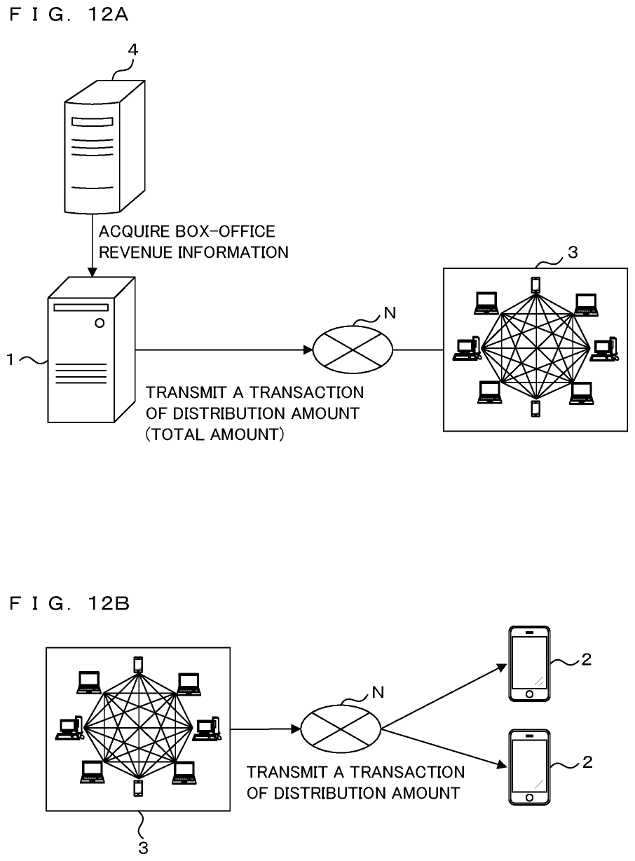

FIGS. 12A and 12B each illustrate the operation of profit distribution processing. FIG. 12A illustrates the operation of acquisition processing for box-office revenue information. The control unit 11 of the server 1 acquires information on box-office revenue from the box-office revenue server 4 via the communication unit 13. More specifically, the control unit 41 of the box-office revenue server 4 acquires information on gross box-office revenue, a production cost ratio and an investor ratio concerning a movie work from the box-office revenue DB 451 of the large capacity storage unit 45 in response to the server 1's request. The control unit 11 of the server 1 calculates the amount of distribution (total amount) to all of the investors based on the acquired box-office revenue information and the profit distribution rule, and transmits the transaction including the calculated distribution amount (total amount) to the blockchain 3. The blockchain 3 receives and stores the transaction including the distribution amount (total amount).

FIG. 12B illustrates the operation of transmission processing for the distribution amount to the investor. The blockchain 3 calculates the distribution amount based on the investment ratio of each of the investors according to the smart contract on which a profit distribution rule is described. The blockchain 3 transmits the calculated amount of distribution to the wallet address of each of the investors stored in FIG. 11C.

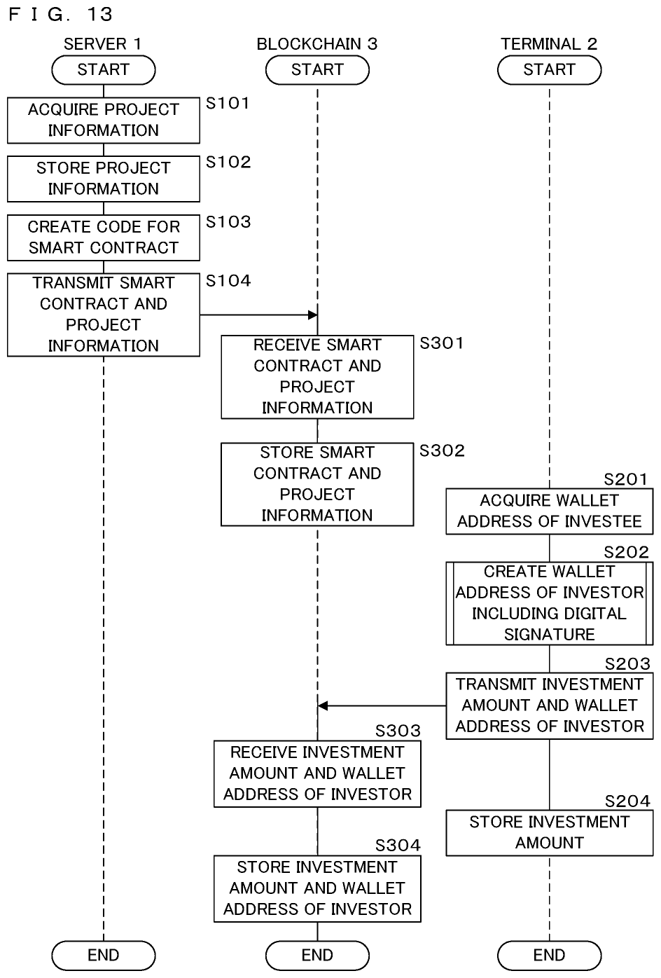

FIG. 13 is a flowchart illustrating the processing procedure performed when investment in a movie work is made. The control unit 11 of the server 1 acquires the project information of a movie work by the input unit 14 (step S101). It is noted that the control unit 11 may acquire the project information of the movie work from an external device (not illustrated) by the communication unit 13. The control unit 11 stores the acquired project information in the project information DB 171 and the planner DB 172 of the large capacity storage unit 17 (step S102). The control unit 11 creates a code for a smart contract in which a profit distribution rule is described referring to the project information DB 171 of the large capacity storage unit 17 (step S103). The control unit 11 transmits the created smart contract and the project information of the movie work to the blockchain 3 through the control unit 13 (step S104). The blockchain 3 receives the smart contract and the project information of the movie work transmitted from the server 1 (step S301) and stores the received smart contract and project information (step S302).

The control unit 21 of the terminal 2 acquires the wallet address of an investee (step S201). The wallet address of the investee may be acquired by receiving the wallet address from the external device by the communication unit 23 and previously storing the investor ID and the wallet address in association with each other in the DB, or by direct delivery of the wallet address from the investee. Alternatively, the control unit 21 may identify a QR code (registered trademark) including the wallet address of the investee by the imaging unit 26 and extract the wallet address. The hash value calculation unit 21a and the digital signature creation unit 21b of the terminal 2 create the wallet address of the investor who makes an investment in the movie work (step S202). A subroutine for the wallet address creation processing will be described later. The control unit 21 of the terminal 2 transmits a transaction, which is directed to the wallet address of the investee from the wallet address of the investor, including the investment amount for the movie work and the wallet address of the investor to the blockchain 3 by the communication unit 23 (step S203). The control unit 21 assigns an investor ID to the investor and stores the investor and the investment amount in association with the project ID of the movie work in the investor DB 173 as one record (step S204). The blockchain 3 receives the investment amount from the transaction including the investment amount and the wallet address of the investor that is transmitted from the terminal 2 (step S303) and stores the received amount of the investment and the wallet address of the investor (step S304). It is noted that a wallet address and an investment amount of each of the investors may previously be stored in the storage unit 12 or the large capacity storage unit 17.

In this case, the server 1 acquires the wallet address and the investment amount of each of the investors from the storage unit 12 or the large capacity storage unit 17 and transmits them to the blockchain 3. This eliminates the need for recreating the wallet address if the investor makes an investment in the movie work again, so that an additional amount of the investment may be transmitted to the blockchain 3 based on the stored wallet address of the investor.

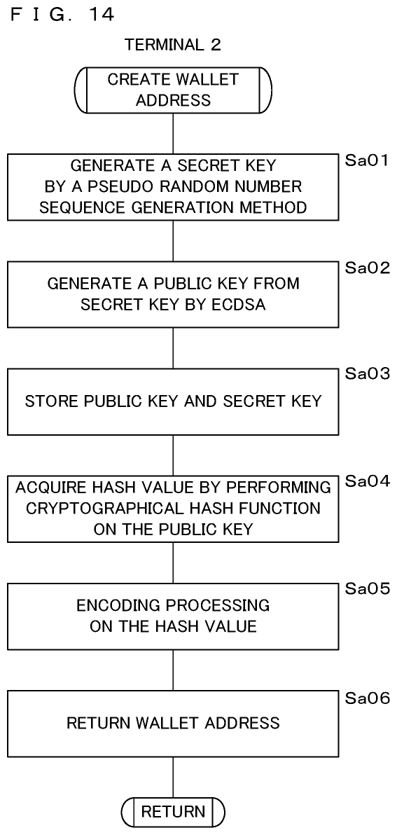

FIG. 14 is a flowchart showing a processing procedure of a subroutine for creating a wallet address. The digital signature creation unit 21b of the terminal 2 generates a secret key by a pseudo random number sequence generation method (step Sa01). The pseudo random number sequence generation method is an algorithm for generating a pseudo random number sequence and can generate a pseudo random number sequence by using a cryptographical hash function, for example. The digital signature creation unit 21b generates a public key by using the generated secret key (step Sa02). For example, by an elliptic curve digital signature algorithm or a Schnorr signature algorithm (ECDSA), a public key may be generated from the secret key. The control unit 21 stores the generated public key and the secret key in the digital signature DB 174 of the large capacity storage unit 17 as one record (step Sa03). The hash value calculation unit 21a calculates and acquires a hash value by performing a cryptographical hash function on the public key (step Sa04). The control unit 21 performs encoding processing on the acquired hash value (step Sa05), and generates and returns a wallet address (step Sa06). It is noted that as to the wallet address creation processing, a wallet address may be created by using another algorithm without being limited to the above-described processing method.

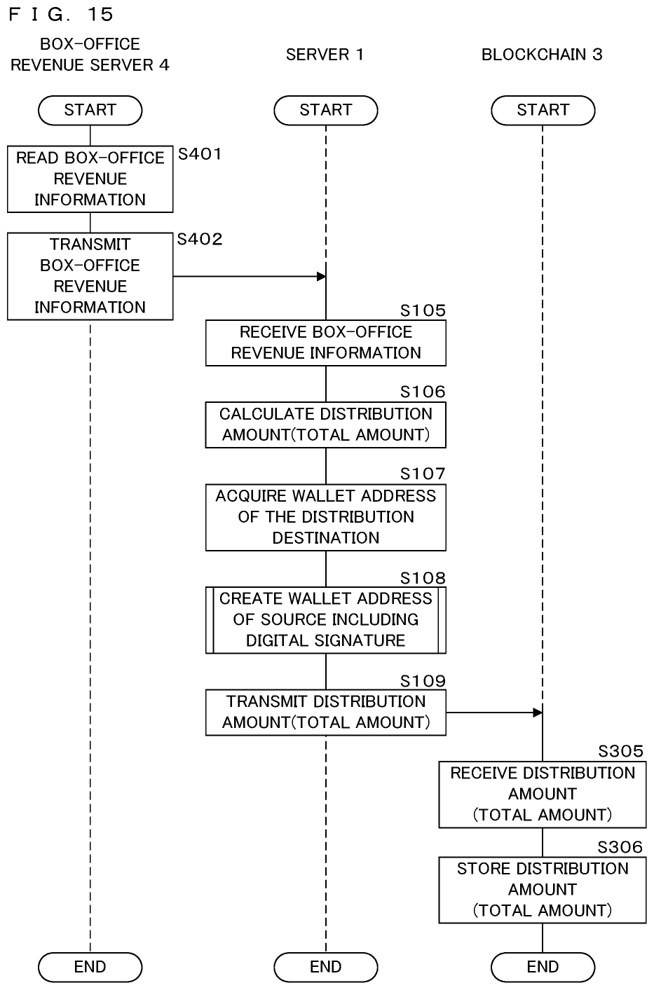

FIG. 15 is a flowchart showing a processing procedure performed when a distribution amount based on box-office revenue information is transmitted. The control unit 41 of the box-office revenue server 4 reads box-office revenue information from the box-office revenue DB 451 of the large capacity storage unit 45 (step S401). The control unit 41 transmits the read box-office revenue information to the server 1 via the communication unit 43 (step S402). The control unit 11 of the server 1 receives the box-office revenue information transmitted from the box-office revenue server 4 by the control unit 13 (step S105). The control unit 11 calculates a distribution amount (total amount) for all of the investors according to the received box-office revenue information (step S106). More specifically, the control unit 11 acquires a gross box-office revenue and the investment ratio information for the investors from the box-office revenue DB 451. The control unit 11 calculates the distribution amount (total amount) of all the investors based on the acquired gross box-office revenue and the investment ratio information of the investors.

The control unit 11 of the server 1 acquires the wallet address of the distribution destination (step S107). It is noted that the acquisition of the wallet address of the distribution destination is the same as that at step S201 in FIG. 13, and thus the description is not repeated here. The hash value calculation unit 11a and the digital signature creation unit 11b of the server 1 create a wallet address for transmitting the distribution amount to the distribution destination (step S108). The subroutine for wallet address creation processing is similar to FIG. 15 and thus the description is not repeated here. The control unit 11 transmits the transaction including the calculated distribution amount (total amount) to the blockchain 3 via the communication unit 13 (step S109). The blockchain 3 receives the distribution amount (total amount) from the transaction including the distribution amount (total amount) transmitted from the server 1 (step S305) and stores the distribution amount (step S306). It is noted that though the box-office revenue server 4 transmits the distribution amount to the blockchain 3 by way of, but not limited to, the server 1. For example, the box-office revenue server 4 may directly transmit the distribution amount to the blockchain 3. The processing of directly transmitting the distribution amount to the blockchain 3 by the box-office revenue server 4 will be described later.

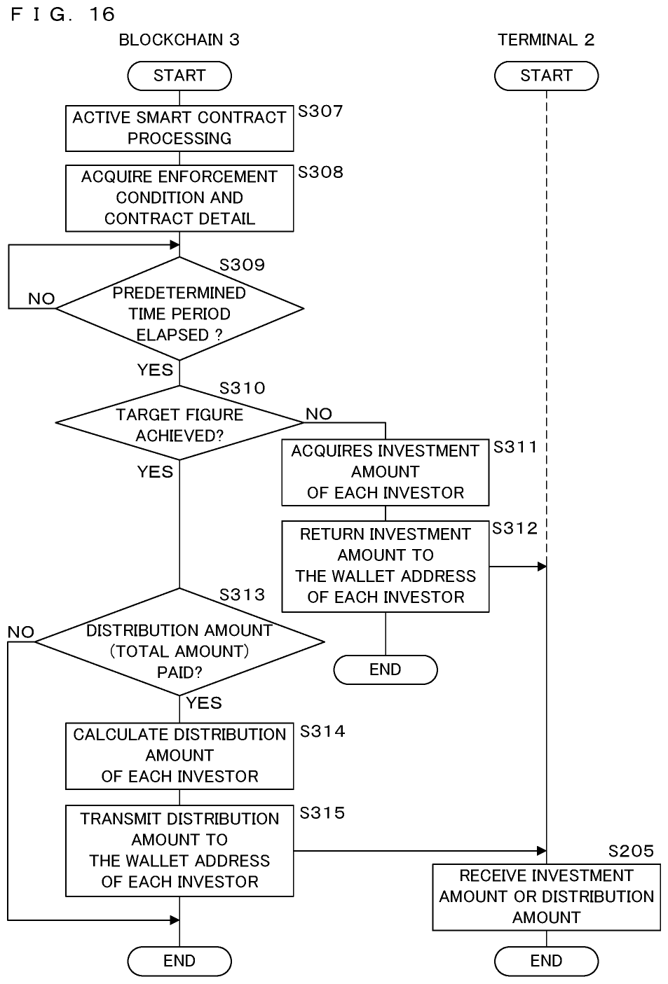

FIG. 16 is a flowchart showing a processing procedure performed when a distribution amount is transmitted to an investor or an investment amount is returned to the investor. The blockchain 3 activates smart contract processing (step S307) and acquires an enforcement condition and the details of the contract in the smart contract (step S308). The blockchain 3 determines whether or not a predetermined time period has elapsed until a target figure is achieved based on the acquired enforcement condition and details of the contract in the smart contract (step S309). The blockchain 3 returns to the determination processing for the lapse of a predetermined time period if determining that the predetermine time period has not elapsed (NO at step S309). The blockchain 3 determines whether or not a target figure for the movie work is achieved (step S310) if determining that the predetermined time period has elapsed (YES at step S309). The blockchain 3 acquires the investment amount of each of the investors (step S311) if determining that the target figure is not achieved (NO at step S310). It is noted that the investment amount and the wallet address of each of the investors are assumed to be described in the smart contract. The blockchain 3 returns the acquired investment amount of each of the investors to the wallet address of each of the investors (step S312) and ends the processing.

The blockchain 3 determines whether or not the distribution amount (total amount) for this movie work is to be paid (step S313) if determining that the target figure is achieved (YES at step S310). The blockchain 3 ends the processing if determining that the distribution amount (total amount) is not to be paid (NO at step S313). The blockchain 3 calculates a distribution amount of each of the investors according to the profit distribution rule described in the smart contract and the investment amount of each of the investors and the distribution amount (total amount) (step S314) if determining that a distribution amount (total amount) for this movie work is to be paid (YES at step S313). For example, if calculation of a distribution amount based on the investment ratio of each of the investors is described in the profit distribution rule, the blockchain 3 calculates an investment ratio based on the investment amount of each of the investors. The blockchain 3 may calculate a distribution amount of each of the investors based on the calculated investment ratio and the distribution amount (total amount). The blockchain 3 transmits the distribution amount calculated for each of the investors to the wallet address of each of the investors stored in the blockchain 3 (step S315). The control unit 21 of the terminal 2 receives the investment amount or the distribution amount transmitted from the blockchain 3 via the communication unit 23 (step S205) and ends the processing.

According to the present embodiment, the investor makes an investment in a movie work via the blockchain 3 to thereby support fund raising for the movie work, resulting in achievement of a cloud funding service.

According to the present embodiment, the box-office revenue is distributed to each of the investors depending on the investment amount of an investor according to the profit distribution rule, which eliminates the intervention of a third party, resulting in a shorter settlement period.

According to the present embodiment, if a target figure for a movie work is not achieved within a predetermined time period, the investment amount paid by an investor is returned to the wallet address of the investor, which can prevent an illegal transaction from occurring.

### Embodiment 2

Embodiment 2 relates to a mode in which a message sending service is utilized in cooperation with a social networking service (SNS) in order to raise much money to be invested in a movie work.

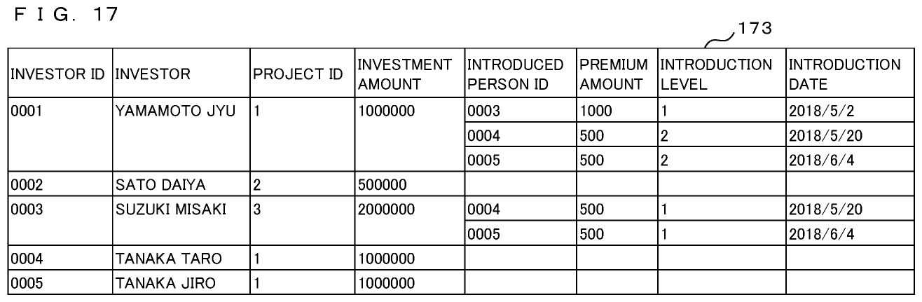

FIG. 17 illustrates one example of the record layout of an investor DB 173 according to Embodiment 2. It is noted that same contents as those in FIG. 6 are not repeated here. The investor DB 173 includes an introduced person ID column, a premium amount column, an introduction level column and an introduction date column. The introduced person ID column stores the ID of an investor (second investor) who makes an investment in a movie work by introduction through an investor (first investor). The premium amount column stores the amount of bonus provided to the first investor if the first investor makes an introduction of the second investor. The introduction level column stores information on the level information concerning direct introduction or indirect introduction. For example, if the first investor makes an introduction of the second investor, the introduction level of the first investor relative to the second investor is stored as “1.” Moreover, if the second investor makes an introduction of the third investor, the introduction level of the first investor relative to the third investor is stored as “2” while the introduction level of the second investor relative to the third investor is stored as “1.” The introduction date column stores a date when an investor make an introduction.

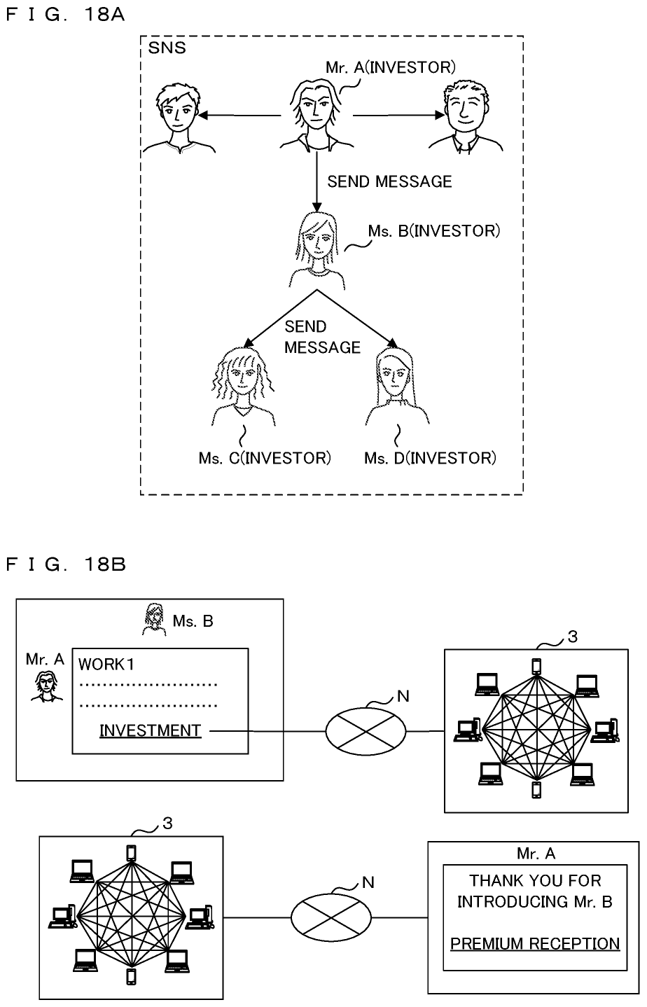

FIGS. 18A and 18B illustrate the outline of a fund-raising system using the SNS. FIG. 18A is a conceptual drawing showing an image in which the project information of a movie work is spread by sending a message using the SNS. For example, in the case where Mr. (or Ms.) A makes an investment in a movie work, the terminal 2 operated by Mr. A registers (logs in) Mr. A in association with an SNS account. Mr. A sends a message to Mr. (or Ms.) B by way of the SNS. The example of the details of the sent message includes project information, etc. including a project and development proposal, a scenario, a plot and a planner for the movie work. It is noted that the project information can include the URL of a project site for the movie work. In this case, the investor ID of an introducer may be added to this URL as a query parameter. For example, in the case where Mr. A makes an introduction of Mr. B, the URL of the project site of a movie work may be the URL address to which the investor ID “0001” of Mr. A is added, that is, “http://www.movie.com/?id=0001.” In this case, the introduction level of Mr. A relative to Mr. B is stored as “1” in the investor DB 173 of the large capacity storage unit 17. In the case where Mr. B further makes an introduction of Mr. (or Ms.) C, the URL of the project site of the movie work may be the URL address to which the investor ID “0001” of Mr. A and the investor ID “0002” of Mr. B are added, that is, “http://www.movie.com/?id=0001_0002.” In this case, the introduction level of Mr. A relative to Mr. C is stored as “2” in the investor DB 173 of the large capacity storage unit 17 while the introduction level of Mr. B relative to Mr. C is stored as “1” in the investor DB 173 of the large capacity storage unit 17. According to the above-described form, the investor ID of the introducer is reflected on the URL in a query parameter form, and this makes it possible to identify the introducer. Furthermore, the value of the introduction level stored in the large capacity storage unit 17 of the investor DB 173 is updated based on the investor ID of the introducer added to the URL at the same time. This shows that the higher the introduction level of the investor is, the larger the number of investors of whom one investor makes an introduction is.

Mr. B can receive a message sent from Mr. A by way of the SNS and confirm the project information, etc. concerning the movie work based on the received message. If Mr. B makes an investment in this movie work, the blockchain 3 can distribute a premium amount to Mr. A based on the profit distribution rule, for example. It is noted that the premium amount may be subtracted from the box-office revenue and distributed. For example, if the ratio of the production cost, the ratio of the investor and the ratio of the premium amount to the total box-office revenue are 60%, 35% and 5%, respectively, 5% of the acquired box-office revenue is distributed to the investors as a premium amount. The distribution rule of the premium amount may be decided by setting a ratio with respect to the investment amount of each investor as well as by setting a fixed amount as a premium amount. If a ratio with respect to the investment amount is set, for example, if the premium amount is set as 0.1% of the investment amount of an investor, the premium amount for the virtual currency quantity of 1000000 is the virtual currency quantity of 1000. It is noted that the premium amount may be distributed based on the introduction level. In this case, if the introduction level is “1,” for example, 0.01% of the total amount of the premium amount may be distributed as a premium amount. If the introduction level is “2,” 0.02% of the total amount of the premium amount may be distributed as a premium amount. If the introduction level is equal to or larger than “5,” 0.05% of the total amount of the premium amount may be distributed as a premium amount.

Mr. B can send a message to Mr. C and Mr. D by way of the SNS. In this case, Mr. B sends a message including the project information, etc. concerning a movie work to Mr. C and Mr. D. If Mr. C and Mr. D make investments in this movie work, the blockchain 3 distributes a premium amount to Mr. B according to the profit distribution rule. It is noted that the blockchain 3 may distribute a premium amount to Mr. A who makes an introduction of Mr. B as well as Mr. B. In this case, the reference of the premium amount to be provided may be specified based on the introduction level. The introduction level of Mr. A relative to Mr. B is set to “1” if Mr. A makes an introduction of Mr. B while the introduction level of Mr. A relative to Mr. C is set to “2” if Mr. B further makes an introduction of Mr. C. For example, if the introduction level is “1,” the premium amount may be determined as 0.1% of the investment amount by an investor. Meanwhile, if the introduction level is “2,” the premium amount may be determined as 0.2% of the investment amount by an investor.

FIG. 18B illustrates the operation of sending a message using the SNS. For example, if receiving a message concerning the project information of a movie work sent from Mr. A, Mr. B presses an “investment” link to perform investment processing to thereby transmit the investment amount to the blockchain 3. After receiving the investment amount transmitted from Mr. B, the blockchain 3 distributes a premium amount to the wallet address of Mr. A stored on the blockchain 3 based on the premium amount distribution rule. As illustrated in the drawing, when pressing the “premium reception” link, Mr. A can receive the premium amount transmitted from the blockchain 3. It is noted that the premium amount may be distributed depending on a distribution amount to be distributed to an investor based on the distribution rule described in the smart contract.

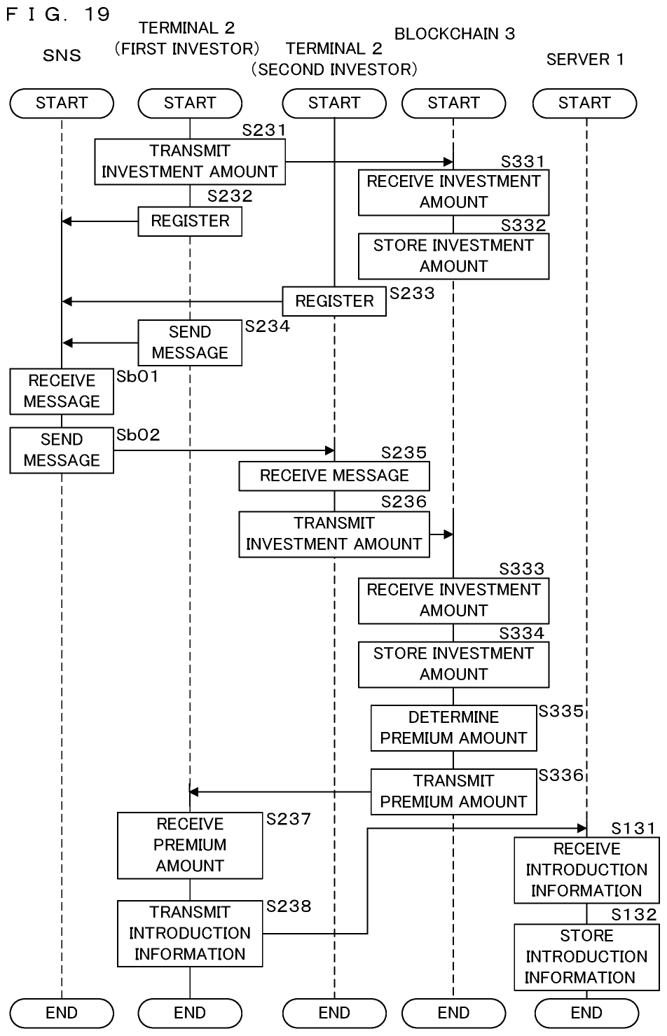

FIG. 19 is a flowchart showing a processing procedure performed when fund-raising in cooperation with the SNS is performed. For the sake of simplicity, the terminal 2 (first investor) is referred to as a terminal 2 (1) while the terminal 2 (second investor) is referred to as a terminal 2 (2).

The control unit 21 of the terminal 2 (1) transmits an investment amount for a movie work to the blockchain 3 via the communication unit 23 of the terminal 2 (1) (step S231). The blockchain 3 receives the investment amount transmitted from the terminal 2 (1) (step S331) and stores the received investment amount (step S332). The control unit 21 of the terminal 2 (1) registers the first investor in association with an SNS account (step S232). The control unit 21 of the terminal 2 (2) registers the second investor in association with an SNS account (step S233).

The control unit 21 of the terminal 2 (1) sends a message to the SNS by the communication unit 23 of the terminal 2 (1) (step S234). The SNS receives the message (step Sb01) and sends the message to the terminal 2 (2) (step Sb02). The control unit 21 of the terminal 2 (2) receives the message by the communication unit 23 of the terminal 2 (2) (step S235) and transmits an investment amount for the movie work to the blockchain 3 (step S236).

The blockchain 3 receives the investment amount transmitted from the terminal 2 (2) (step S333) and stores the investment amount (step S334). The blockchain 3 determines a premium amount to be distributed to the first investor according to the profit distribution rule (step S335). The blockchain 3 transmits to the terminal 2 (1) the determined premium amount directed to the wallet address corresponding to the first investor ID (step S336). The control unit 21 of the terminal 2(1) receives the premium amount transmitted from the blockchain 3 via the communication unit 23 of the terminal 2 (1) (step S237).

The control unit 21 of the terminal 2(1) transmits introduction information on the investor introduced by way of the SNS to the server 1 (step S238). The control unit 11 of the server 1 receives the introduction information transmitted from the terminal 2 (1) (step S131) and stores the introduction information in the investor DB 173 of the large capacity storage unit 17 (step S132). More specifically, the control unit 11 stores the introduced person ID, premium amount, introduction level and introduction date, which are associated with the investor ID, in the investor DB 173 as one record.

According to the present embodiment, the fund raising for a movie work is spread in cooperation with the SNS, which can enhance public recognition of the movie work. This makes it possible to collect more investors, which ensures the fund for producing a movie work.

### Embodiment 3

The investor can participate in selection of a cast appearing in a movie work and a production company producing the movie work. In the present embodiment, the investor casts votes on a cast and a production company to thereby claim the investor's right to participate.

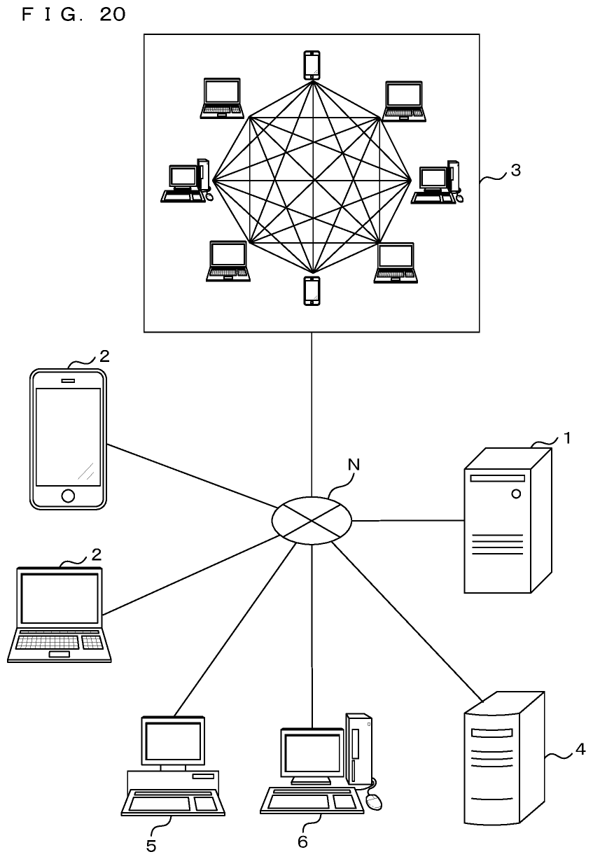

FIG. 20 illustrates the outline of a vote system for casting votes on a cast and a production company. Note that same contents as those of Embodiment 1 are not repeated here. In the present embodiment, the system includes a cast information processing terminal 5 and a production company information processing terminal 6, and sends and transmits information over the network N such as the Internet or the like.

The cast information processing terminal 5 is a terminal device for displaying the project information and the box-office revenue information of a movie work concerning a cast and receiving a box-office revenue, for example, and is an information processing device such as a smartphone, a cellular phone, a tablet, a personal computer terminal or the like. For the sake of simplicity, the cast information processing terminal 5 is referred to as a cast terminal 5.

The production company information processing terminal 6 is a terminal device for transmitting and receiving information on the production of a movie work, displaying the box-office revenue information, and receiving the box-office revenue, for example, concerning a production company producing a movie work. It is an information processing device such as a smartphone, a cellular phone, a tablet, a personal computer terminal or the like. For the sake of simplicity, the production company information processing terminal 6 is referred to as a production company terminal 6.

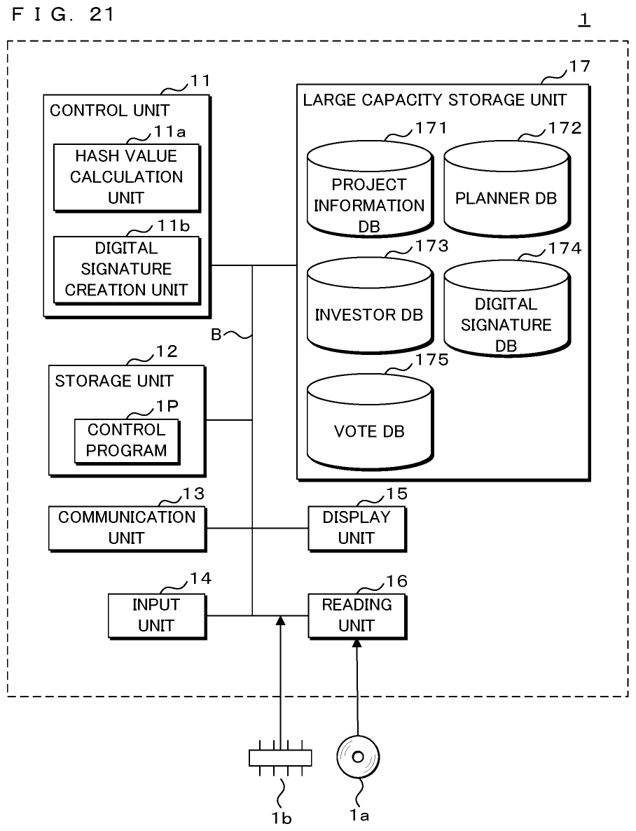

FIG. 21 is a block diagram illustrating one example of the configuration of the server 1 according to Embodiment 3. Note that same contents as FIG. 3 are denoted by the same reference codes and the description thereof will not be repeated. The large capacity storage unit 17 includes a vote DB 175. The vote DB 175 stores the number of votes for a cast and a production company, etc. that investors cast votes.

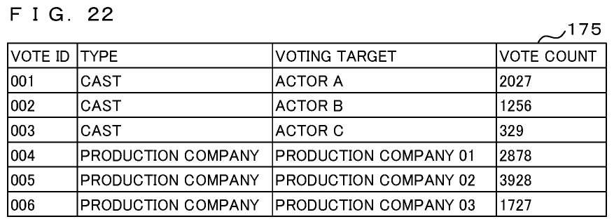

FIG. 22 illustrates one example of the record layout of the vote DB 175. The vote DB 175 includes a vote ID column, a type column, a voting target column and a vote count column. The vote ID column stores the ID of vote information uniquely specified for identifying vote information. The type column stores the type information of a voting target. The examples include a cast or a production company. The voting target column stores information on a target to be voted. For example, if the type is a cast, the voting target column may store the name of a cast as a candidate. If the type is a production company, the voting target column may store the company name of a production company as a candidate. The vote count column stores the number of votes for the voting target.

Next, the entire flow of voting for a cast and a production company will be described. The control unit 11 of the server 1 receives the candidates for a cast and a production company by the input unit 14. It is noted that the method of receiving the candidates for a cast and a production company is not limited to the above-described method. For example, the control unit 11 may receive the candidates for a cast and a production company from an external device (not illustrated) via the communication unit 13. Alternatively, the control unit 11 of the server 1 may directly communicate with the cast terminal 5 and the production company terminal 6 through the communication unit 13 and receive the candidates.

The control unit 11 of the server 1 receives votes for the candidates of the cast and the production company from the investor and stores the votes in the vote DB 175 of the large capacity storage unit 17. More specifically, the control unit 11, for example, stores the number of votes transmitted from the terminal 2 by the communication unit 13 in association with the type and the voting target in the vote DB 175 as one record. The control unit 11 selects a cast and a production company based on the number of votes stored in the vote DB 175. For example, the cast and the production company may be selected in descending order of the number of votes gained during a predetermined period.

After a movie work is shown, the acquired box-office revenue is distributed to the cast and the production company at predetermined ratios based on the profit distribution rule. It is noted that the profit distribution may be made by legal currency or by virtual currency using the blockchain 3. More specifically, in the case of the virtual currency, the control unit 11 of the server 1 receives information, etc. such as a gross box-office revenue and the production cost ratio from the box-office revenue server 4 via the communication unit 13. The control unit 11 calculates the distribution amount of the box-office revenue for the cast and the production company depending on the received gross box-office revenue and production cost ratio, and transmits the calculated distribution amount to the blockchain 3. The blockchain 3 transmits the received distribution amount to the wallet addresses of the cast and the production company. It is noted that in the present embodiment, the cast ratio information and the production company ratio information are acquired from, but not limited to, the box-office revenue server 4. For example, the blockchain 3 may calculate the distribution amount for the cast and the production company according to the smart contract in which the profit distribution rule is described.

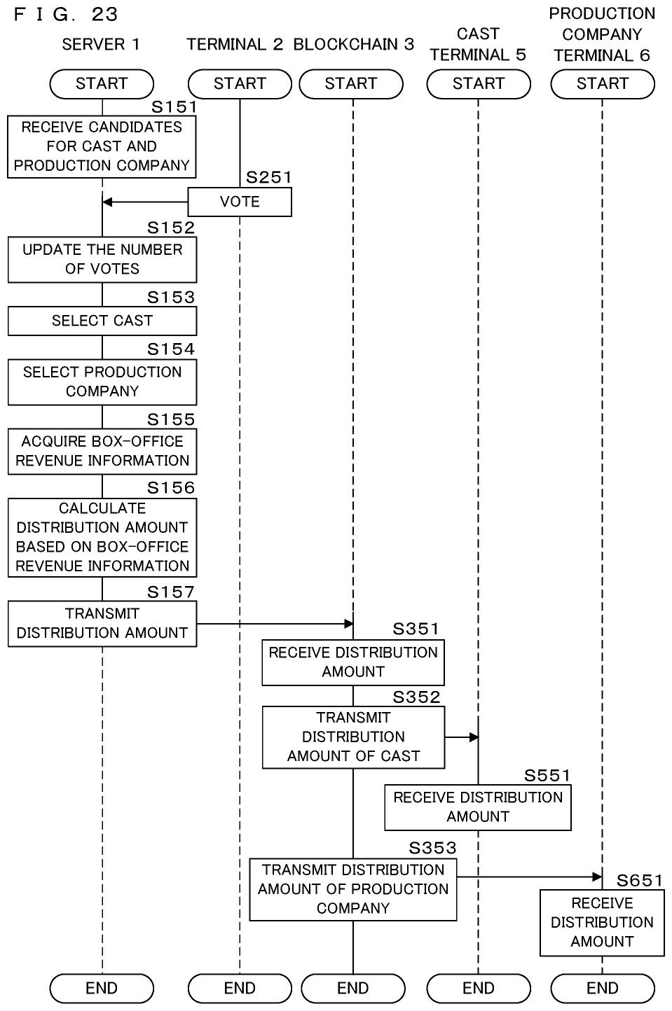

FIG. 23 is a flowchart of a processing procedure performed when voting on a cast and a production company is made. The control unit 11 of the server 1 receives candidates for a cast and a production company by the communication unit 13 or the input unit 14 (step S151). The control unit 21 of the terminal 2 transmits votes for the cast and the production company to the server 1 via the communication unit 23 (step S251). The control unit 11 of the server 1 receives the votes transmitted from the terminal 2 by the communication unit 13 and updates the number of votes in the vote DB 175 in association with the cast and the production company (step S152). The control unit 11 of the server 1 selects a cast (step S153) and selects a production company (step S154), based on the number of votes. The control unit 11 acquires the box-office revenue information for the movie work (step S155). The control unit 11 calculates distribution amount for the cast and the production company based on the acquired box-office revenue information (step S156) and transmits the calculated distribution amount to the blockchain 3 (step S157).

The blockchain 3 receives the distribution amount for the cast and the production company that are transmitted from the server 1 (step S351). The blockchain 3 transmits the distribution amount to be distributed to the cast to the cast terminal 5 (step S352). The cast terminal 5 receives the distribution amount transmitted from the blockchain 3 (step S551). The blockchain 3 transmits the distribution amount to be distributed to the production company to the production company terminal 6 (step S353). The production company terminal 6 receives the distribution amount transmitted from the blockchain 3 (step S651).

According to the present embodiment, the investor selects a cast and a production company based on the number of votes for a cast appearing in the movie work and a production company producing the movie work on which each investor casts votes. This makes it possible to select a cast and a production company with reference to opinions from investors, which enhances the quality of a movie work.

According to the present embodiment, the box-office revenue is distributed to a cast and a production company at predetermined ratios according to the profit distribution rule, which simplifies the proceeding of the profit distribution.

### Embodiment 4

The box-office revenue may be distributed to investors by year, by quarter of the year or by month as well as in bulk. In the present embodiment, an example in which the box-office revenue is distributed by month is described.

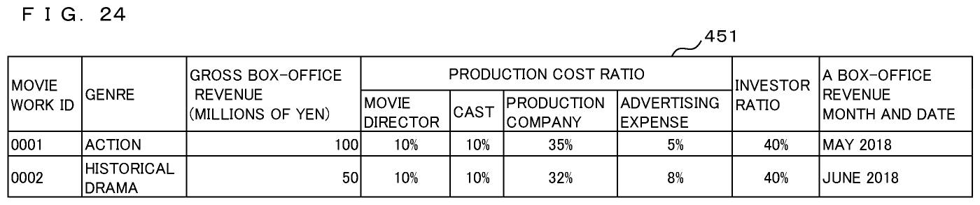

FIG. 24 illustrates one example of a record layout of a box-office revenue DB 451 according to Embodiment 4. It is noted that same contents as those in FIG. 10 are not repeated here. The box-office revenue DB 451 includes a box-office revenue month and date column. The box-office revenue month and date column stores information on a target year and month of the box-office revenue.

The control unit 41 of the box-office revenue server 4 acquires box-office revenue information and extracts the box-office revenue information by month. The control unit 41 calculates a distribution amount to be distributed to an investor based on the extracted box-office revenue information. The control unit 41 performs the exchange of the virtual currency quantity corresponding to the distribution amount by the communication unit 43 by way of the system at the exchange, for example. The exchange processing of the virtual currency will not be repeated here since it is similar to that in Embodiment 1. The box-office revenue server 4 creates a code for the smart contract and transmits the created code for the smart contract and the distribution amount to the blockchain 3 via the communication unit 43.

The blockchain 3 receives and stores the code for the smart contract and the distribution amount transmitted from the box-office revenue server 4. The blockchain 3 calculates the distribution amount of each of the investors based on the profit distribution rule described in the code for the smart contract and the investment amount of each of the investors. The blockchain 3 transmits the calculated distribution amount to the wallet address of each of the investors stored on the blockchain 3.

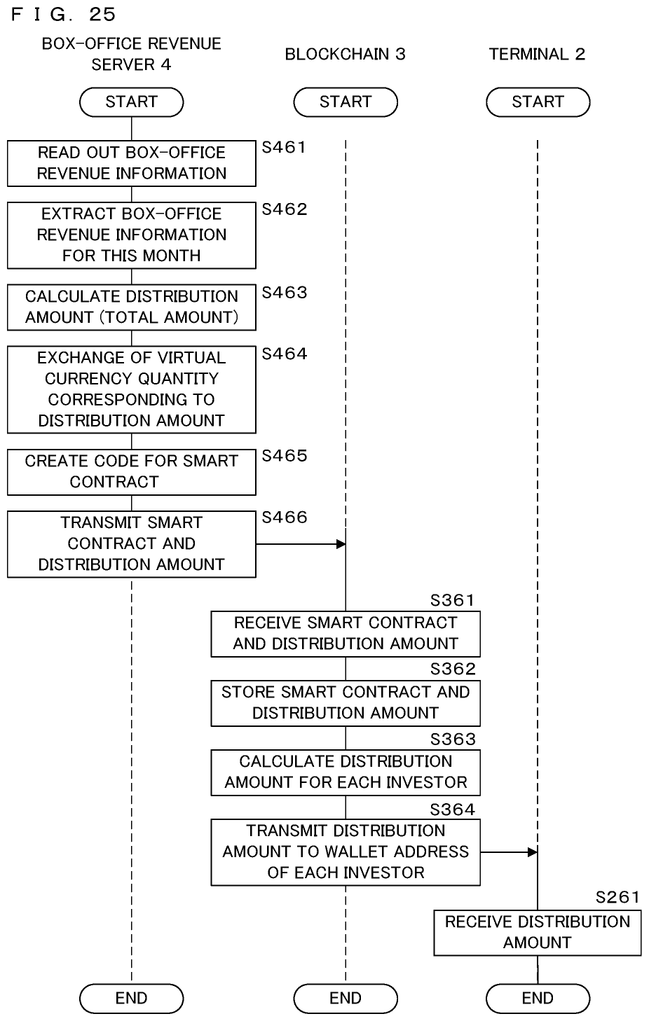

FIG. 25 is a flowchart showing a processing procedure performed when box-office revenue is distributed by month. The control unit 41 of the box-office revenue server 4 reads out box-office revenue information including gross box-office revenue, an investor ratio, etc. from the box-office revenue DB 451 of the large capacity storage unit 45 (step S461). The control unit 41 extracts the box-office revenue information for this month from the box-office revenue month and date column of the box-office revenue DB 451 (step S462). The control unit 41 calculates the distribution amount (total amount) of the investors based on the extracted box-office revenue information by this month (step S463). The control unit 41 performs the exchange of virtual currency quantity corresponding to the amount of distribution (step S464). The control unit 41 then creates a code for the smart contract in which the profit distribution rule is described (step S465). It is noted that the smart contract including enforcement conditions and details of the contract for each month may previously be registered in the box-office revenue server 4 collectively. If a transaction that is coincident with the enforcement conditions and the details of the contract occurs for each month, the contract can automatically be implemented. The control unit 41 transmits the smart contract and the distribution amount to the blockchain 3 via the communication unit 43 (step S466).

The blockchain 3 receives the smart contract and the distribution amount that are transmitted from the box-office revenue server 4 (step S361) and stores the received smart contract and distribution amount (step S362). The blockchain 3 calculates a distribution amount for each of the investors according to the profit distribution rule described in the smart contract (step S363). The blockchain 3 transmits the calculated distribution amount of each of the investors to the wallet address of each of the investors stored in the blockchain 3 (step S364). The control unit 21 of the terminal 2 receives the distribution amount transmitted from the blockchain 3 by the communication unit 23 (step S261).

According to the present embodiment, it is possible to distribute the box-office revenue to each of the investors by year, by quarter of the year or by month.

### Embodiment 5

Embodiment 5 relates to a mode in which box-office revenue is distributed to each of the investors depending on the degree of achievement of the target figure for a movie work. The degree of achievement of a target figure is the degree at which the target figure is achieved. For example, if 60% of the total target figure is achieved, the degree of achievement of the target figure is 60%. Furthermore, various profit distribution rules may be decided for each of the degrees of achievement of the target figure. For example, if the degree of achievement of the target figure is 60%, 40% of the box-office revenue may be distributed to the investors.

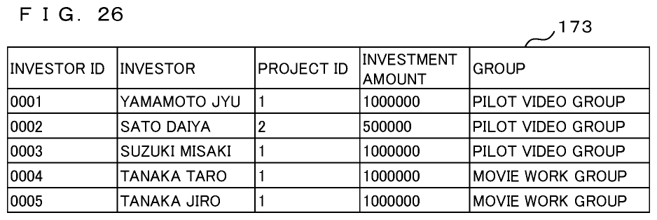

FIG. 26 illustrates one example of the record layout of an investor DB 173 according to Embodiment 5. Note that same contents as those of FIG. 6 are not repeated here. The investor DB 173 includes a group column. The group column stores information on a target group to be invested according to the degree of achievement of a target figure to produce a movie work. It is noted that the group column stores a pilot video group and a movie work group in the present embodiment.

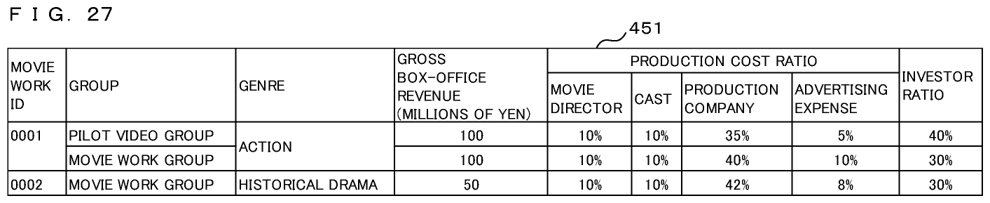

FIG. 27 illustrates one example of the record layout of a box-office revenue DB 451 according to Embodiment 5. Note that same contents as those of FIG. 10 are not repeated here. The box-office revenue DB 451 includes a group column. The group column stores information on a targeting group to be invested. Different ratios of the production cost and different ratios of the investor are set for each group information. In the embodiment, for example, a pilot video group and a movie work group are previously set. Here, the ratio of the investor in association with the pilot video group is set higher than the ratio of the investor in association with the movie work group. Thus, considering that the starting time of the investment has an influence on the profit, an early investment is set to acquire a higher earning rate.

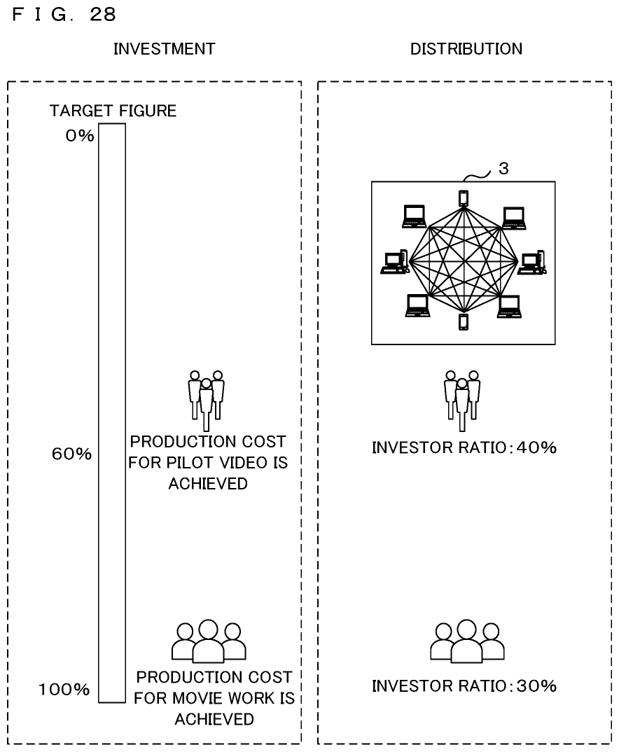

FIG. 28 is a conceptual drawing illustrating profit distribution depending on the degree of achievement of the target figure. In the present embodiment, for the degree of achievement of the target figure for producing a movie work, two types of the degree of achievement are set including the degree of achievement 60% and the degree of achievement 100%. If the degree of achievement reaches 60%, the target figure of the production cost for the pilot video is achieved while if the degree of achievement reaches 100%, the target figure of the production cost for the movie work is achieved.

If an investor makes an investment during a first public offering relating to the production cost for a pilot video, an investor ID is assigned to the investor, and information such as the investor, the investment amount, the pilot video group, etc. is stored in the investor DB 173 of the large capacity storage unit 17 as one record. If an investor makes an investment during a second public offering relating to the production cost for a final movie work after completion of the first public offering, an investor ID is assigned to the investor, and information such as the investor, an investment amount, the movie work group, etc. is stored in the investor DB 173 of the large capacity storage unit 17 as one record.

After the degree of achievement of the target figure for each of the groups is achieved, information on the box-office revenue is acquired from the box-office revenue DB 451 of the large capacity storage unit 45 for each of the groups. More specifically, if the target figure of the production cost for a pilot video is achieved, and the box-office revenue is acquired, for example, the gross box-office revenue and the investor ratio information are acquired from the box-office revenue DB 451 with reference to the pilot video group. The distribution amount of the investor is calculated based on the gross box-office revenue and the investor ratio information and is distributed to each of the investors.

According to the present embodiment, the degree of achievement of the target figure is set to thereby enable fund raising required for producing a movie work in a stepwise manner, not at a time. This makes it possible to avoid a risk of investing too much money.

### Embodiment 6

Embodiment 6 relates to a mode in which a person other than an investor also casts a vote. Note that same contents as those of Embodiment 3 are not repeated here.

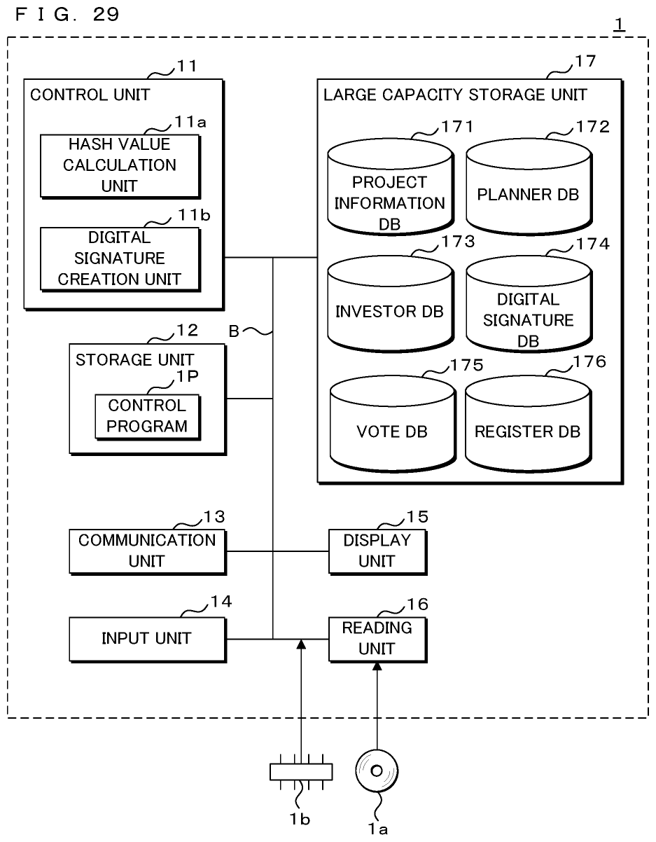

FIG. 29 is a block diagram illustrating the configuration example of a server 1 according to Embodiment 6. Note that same contents as FIG. 21 are denoted by the same reference codes and the description thereof will not be repeated. The large capacity storage unit 17 includes a register DB 176. The register DB 176 stores information on a register who casts votes for the scenario, the appearing cast and the pilot video of a movie work.

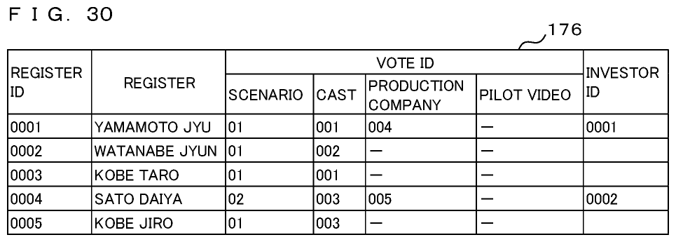

FIG. 30 illustrates one example of the record layout of a register DB 176. The register DB 176 includes a register ID column, a register column, a vote ID column and an investor ID column. The register ID column stores the ID of a register uniquely specified for identifying each of the registers. The register column stores the name of a register. The vote ID column includes a scenario column, a cast column, a production company column and a pilot video column. The scenario column stores a vote ID for a scenario for which a register casts a vote.

In the example of FIG. 30, the vote ID “01” for the scenario means that casting a vote for a scenario A is made while the vote ID “02” for the scenario means that casting a vote for a scenario B is made. The cast column stores a vote ID for a cast for which a register casts a vote. The production company column stores a vote ID for a production company for which a register (investor) casts a vote. It is noted that if the register is not an investor, the register cannot cast a vote for the production company in the present embodiment, though not limited thereto. The pilot video column stores a vote ID of a pilot video for which a register casts a vote. Note that in the present embodiment, the pilot video column cannot be votable since a pilot vide o has not yet been produced, and the pilot video column thus stores “-.” The investor ID column stores an investor ID assigned when a register makes an investment in a movie work.

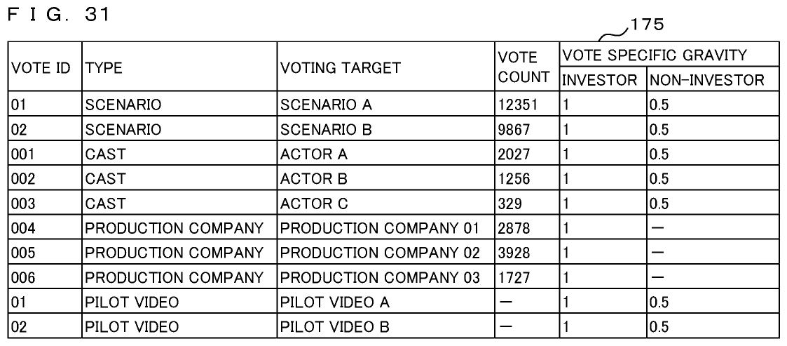

FIG. 31 illustrates one example of the record layout of a vote DB 175 according to Embodiment 6. Note that same contents as those in FIG. 22 are not repeated here. The vote DB 175 includes a vote specific gravity column. The vote specific gravity column includes an investor column and a non-investor column. The investor column stores specific gravity information on a vote of an investor upon voting. The non-investor column stores specific gravity information on a vote of a non-investor upon voting. It is noted that though an example is shown in which the specific gravity of a vote of the investor is set to be heavier than that of the non-investor in the present embodiment, another example may be conceivable. For example, the ratio of the specific gravity of votes of an investor and a non-investor may be equal, i.e., 1:1.

The following describes an example in which the specific gravity of a vote of an investor is set to 1 while the specific gravity of a vote of a non-investor is set to 0.5. If the investor and the non-investor cast votes for actor A, the total number of gained votes is calculated for each of the investor and the non-investor based on the rule for setting a specific gravity of a vote described above. For example, if one hundred investors cast votes for actor A and fifty non-investors cast votes for actor A, the total number of gained votes is 100+50/2=125.

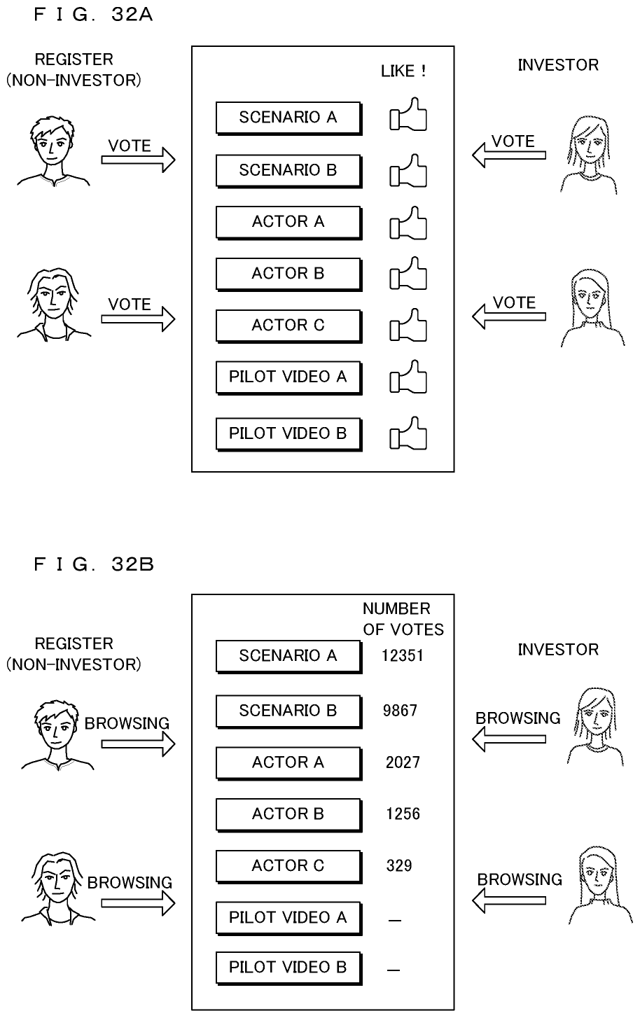

FIGS. 32A and 32B each illustrate operation of casting a vote and browsing vote information in the vote system. FIG. 32A illustrates a state in which registers vote for a scenario, a cast and a pilot video. The control unit 21 of the terminal 2 can receive votes for the scenario, cast and pilot video from each of the registers by the input unit 24 and can totalize the number of votes. More specifically, if a register presses a “like!” button for each of the scenario, the cast and the pilot video, the number of votes is totalized. In the case where a register casts a vote for “actor A,” for example, the register presses a “like!” button to allow the control unit 21 of the terminal 2 to transmit the information of the register and the vote information to the server 1 via the communication unit 23. The control unit 11 of the server 1 acquires the specific gravity information for a vote of the non-investor from the vote specific gravity column of the vote DB 175 stored in the large capacity storage unit 17 and calculates the total number of gained votes according to the acquired specific gravity information. The control unit 11 adds the total number of gained votes calculated to the vote count column of the vote DB 175 and updates the value of the vote count column.

FIG. 32B illustrates a state in which registers browse vote information. Regardless of whether a register makes an investment in a movie work or not, the register can browse the vote information including the number of votes. More specifically, the control unit 11 of the server 1 reads out the number of votes for each of the scenario, the cast and the pilot video from the vote DB 175 of the large capacity storage unit 17 and transmits them to the terminal 2 via the communication unit 13. The control unit 21 of the terminal 2 receives the number of votes transmitted from the server 1 by the communication unit 23 and displays the number of votes for each of the scenario, the cast and the pilot video through the display unit 25.

According to the present embodiment, a register who does not invest in a project of a movie work can vote for this project.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

What is claimed is:

1. An information processing method, comprising:
receiving an investment amount for a movie work from a wallet of an investor;
storing the investment amount for each investor on blockchain;
acquiring information on box-office revenue of the movie work after a target figure to produce the movie work is achieved; and
distributing the box-office revenue to each investor according to the investment amount and a profit distribution rule.

2. The information processing method according to claim 1, further comprising returning the investment amount received to a wallet address of the investor according to a smart contract in which the profit distribution rule is described if the target figure is not achieved within a predetermined time period.

3. The information processing method according to claim 1, wherein
a distribution amount for each investor is determined according to the smart contract in which the profit distribution rule is described and the investment amount,
the method further comprising transmitting the distribution amount determined a destination of which is the wallet address of the investor to the blockchain.

4. The information processing method according to claim 1, further comprising registering an investor for the movie work and an SNS account so as to be associated with each other.

5. The information processing method according to claim 4, further comprising:
determining a premium amount to be distributed to a first investor according to the profit distribution rule if a second investor who made an investment in response to a message sent from the first investor registered is specified; and
transmitting the premium amount determined, directed to a destination of a wallet address of the first investor to the blockchain.

6. The information processing method according to claim 1, further comprising
receiving candidates for a cast appearing in the movie work and candidates for a production company to produce the movie work, and
selecting a cast and a production company from the candidates,
wherein the box-office revenue is distributed to the cast and the production company at a predetermined ratio according to the profit distribution rule.

7. The information processing method according to claim 6, further comprising:
receiving votes for the cast and the production company from the investor; and
selecting a cast and a production company from the candidates based on the number of votes.

8. The information processing method according to claim 1, wherein
a first target for the target figure includes a production cost for a pilot video, and
a second target for the target figure includes a production cost for the movie work.

9. An information processing apparatus comprising the one or a plurality of processors and a storage, the processor executing the following processing of:
receiving an investment amount for a movie work from a wallet of an investor;
storing the investment amount for each investor on blockchain in the storage;
acquiring information on box-office revenue of the movie work after a target figure to produce the movie work is achieved; and
distributing the box-office revenue to each investor according to the investment amount and a profit distribution rule.

10. A non-transitory computer-readable storage medium storing a program that causes a computer to execute processing of:
receiving an investment amount for a movie work from a wallet of an investor;
storing the investment amount for each investor on blockchain;
acquiring information on box-office revenue of the movie work after a target figure to produce the movie work is achieved; and
distributing the box-office revenue to each investor according to the investment amount and a profit distribution rule.
